(19) United States
(12) Patent Application Publication
(10) Pub. No.: US 2021/0253459 A1
(43) Pub. Date: Aug. 19, 2021

(54) Effluent Filtering System and Related Method

(71) Applicant: RAS Services, L.L.C., Baton Rouge, LA (US)

(72) Inventor: Stephen William ABERNATHY, Robert, LA (US)

(21) Appl. No.: 16/795,177

(22) Filed: Feb. 19, 2020

(51) Int. Cl. C02F 3/08; C02F 3/04

(52) U.S. Cl. CPC C02F 3/087; C02F 2103/20; C02F 3/04

(57) ABSTRACT

One or more systems are described for filtering waste water, and related methods. A system is described that includes at least one effluent feed line configured to receive an effluent liquid to be filtered and extending into a respective filter body, a particulate medium or bed disposed and retained in filter body by retention means for retaining the particulate medium or bed at or adjacent to a top portion of the filter body. A method is described that includes feeding effluent through an effluent feed line into a lower portion of a filter body in which is disposed a particulate medium or bed, retaining the particulate medium or bed in filter body while overflowing filtered output from the filter body through an outlet of the filter body, and initiating a media wash cycle.

### TECHNICAL FIELD

The present disclosure relates to waste water filtering systems and related methods, and more specifically those which employ a particulate filter medium or bed.

### BACKGROUND

This section introduces information that may be related to or provide context for some aspects of the techniques described herein and/or claimed below. This information is background facilitating a better understanding of that which is disclosed herein. Such background may include a discussion of “related” art. That such art is related in no way implies that it is also “prior” art. The related art may or may not be prior art. The discussion is to be read in this light, and not as admissions of prior art.

According to Food and Agriculture Organization, “aquaculture” refers to the farming of aquatic organisms including fish, mollusks, crustaceans and aquatic plants. Fish aquaculture is one of the fastest growing sectors of agriculture in the world today. It can involve raising fish in controlled areas filled with water such as tanks, ponds, and ocean enclosures. One of the by-products of raising fish in such controlled areas is the production of waste including solid wastes such as excreta, fecal matter and uneaten feed from fish.

The solid wastes need to be removed from the water in controlled area. Solid wastes can be removed from or significantly in the water by using waste water treatment systems such as, for example, a fluidized bed reactor including a screen for filtering solid wastes from the water. However, such systems often have high energy requirements and require a large amount of water. Further, screens utilized in such systems can become clogged, resulting in costly system downtime and maintenance.

Thus, there is a need for new and improved systems and methods that minimize or reduce the impact from these and other limitations.

### NON-LIMITING SUMMARY

In general, the present disclosure provides one or more systems for filtering waste water and related methods.

In an aspect, a system for filtering waste water is provided. The system includes (A) at least one effluent feed line configured to receive an effluent liquid to be filtered and extending into a respective filter body, the filter body defining a bottom portion and a top portion; and (B) a microbe-seeded, floating particulate media bed disposed and retained in the filter body by retention means for retaining the particulate media bed at or adjacent to the top portion of the filter body. The system is configured so that during filter operation, the effluent liquid upwells through one or more perforations in the effluent feed line and upwardly into and through the particulate media bed and out of the filter body through an opening formed at the top portion of the filter body, the particulate media bed remaining substantially static. The system is configured so that during media washing operation the particulate media bed becomes fluidized as the result of a feed of a solvent through one or more nozzles introducing the feed of solvent to filter body below a plane occupied by the retention means, so as to displace the medium of the particulate media bed sufficiently to dislodge at least a portion of solid waste and excess bacteria thereon and form waste wash, the waste wash thereafter settling to the bottom portion of the filter body following termination of the feed of the solvent through the one or more nozzles. The filter body further includes one or more discharge outlets for draining the filter body and media bed of the settled waste wash following termination of the feed of solvent through the one or more nozzles and preparatory to the particulate media bed being placed back into service for repeated filtering operation upon the resumption of effluent feeding into the effluent feed line.

One or more aspects include the system of the preceding paragraph wherein the waste water comprises waste water formed from fish aquaculture operations.

One or more aspects include the system of any preceding paragraph wherein the retention means comprises a screen.

One or more aspects include the system of any preceding paragraph wherein the particulate media bed comprises one or more floating filter beds.

In another aspect, a method for filtering waste water is provided. The method includes (A) feeding effluent through an effluent feed line into a bottom portion of a filter body in which is disposed a floating, microbe-seeded, particulate media; (B) retaining the particulate media in the filter body so that the particulate media is substantially static during effluent feeding while overflowing a filtered output from the filter body through a top portion of the filter body, and (C) initiating a media wash cycle, the wash cycle. The wash cycle includes (i) terminating the feeding of effluent while injecting a flow of solvent through one or more solvent feed lines into the particulate media, to thereby fluidize the particulate media into a state of agitation so that solids adhered to the medium are dislodged therefrom, (ii) terminating the injecting of the flow of solvent to permit dislodged waste solids to settle out of the particulate medium and settle in the bottom portion of the filter body, and (iii) draining the bottom portion of the filter body to remove waste solids settled in the bottom portion of the filter body. Once the draining of the bottom portion of the filter body is completed, the method may be repeated.

One or more aspects include the method of the preceding paragraph wherein the solvent is water or an aqueous medium.

One or more aspects include the method of any preceding paragraph wherein the waste water comprises waste water formed from fish aquaculture operations.

In still another aspect, a method for filtering waste water formed from fish aquaculture operations is provided. The method includes (A) feeding effluent through an effluent feed line into a bottom portion of a filter body in which is disposed a particulate media bed, (B) retaining the particulate media bed in the filter body so that the particulate media bed is substantially static during effluent feeding, (C) overflowing a filtered output exiting the particulate media bed through a top portion of the filter body, (D) terminating the feeding of effluent to the filter body, (E) injecting a flow of solvent through a filter wash into the particulate media bed thereby fluidizing the particulate media bed into a state of agitation so that solids adhered to the particulate media bed are dislodged therefrom, (F) terminating the injecting of the flow of solvent to permit dislodged waste solids to settle in the bottom portion of the filter body, and (G) draining the bottom portion of the filter body to remove waste solids settled in the bottom portion of the filter body.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE DRAWINGS

For a detailed description of the preferred embodiments of the disclosed embodiments, reference will now be made to the accompanying drawing(s) in which:

FIG. 1 illustrates a system in accordance with certain aspects of the subject matter described herein when effluent is introduced to and filtered by the system.

FIG. 2 illustrates a system in accordance with certain aspects of the subject matter described herein during a media wash cycle.

FIG. 3 illustrates a system in accordance with certain aspects of the subject matter described herein during a media wash cycle.

FIG. 4 illustrates a system in accordance with certain aspects of the subject matter described herein during a media wash cycle.

FIG. 5 illustrates a system in accordance with certain aspects of the subject matter described herein after a media wash cycle and when effluent is introduced to and filtered by the system.

FIG. 6 illustrates a bottom portion of a system in accordance with certain aspects of the subject matter described herein.

While the claimed subject matter is susceptible to various modifications and alternative forms, the drawing(s) illustrate specific embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### Definitions

To more clearly define the terms used in this disclosure, the following definitions are provided. Unless otherwise indicated, the following definitions are applicable to this disclosure. To the extent that any definition or usage provided by any document incorporated here by reference conflicts with the definition or usage provided herein, the definition or usage provided in this disclosure controls.

In this disclosure, features of the subject matter are described such that, within particular aspects, a combination of different features can be envisioned. For each and every aspect and each and every feature disclosed herein, all combinations that do not detrimentally affect the designs, systems, or methods described herein are contemplated with or without explicit description of the particular combination. Additionally, unless explicitly recited otherwise, any aspect or feature disclosed herein can be combined to describe inventive designs, systems, processes, or methods consistent with the present disclosure.

In this disclosure, while systems and method are often described in terms of “comprising” various components or steps, the systems and methods can also “consist essentially of” or “consist of” the various components or steps, unless stated otherwise. For example, a method consistent with certain aspects of the disclosed subject matter can comprise; alternatively, can consist essentially of; or alternatively, can consist of; a feeding step, a retaining step, and an initiating a wash cycle step.

The terms “a,” “an,” and “the” are intended to include plural alternatives, e.g., at least one, one or more, and one or more than one, unless otherwise specified. For example, the disclosure of “a solvent,” is meant to encompass one, or mixtures or combinations of more than one, solvent, unless otherwise specified.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities.

The term “ambient temperature” is used herein to describe any temperature from 5° C. to 40° C. wherein no external heat or cooling source is directly applied to the filter body. Accordingly, the term “ambient temperature” encompass the individual temperatures and any and all ranges, subranges, and combinations of subranges of temperatures from 5° C. to 40° C. wherein no external heating or cooling source is directly applied to the filter body.

The term “ambient pressure” is used herein to describe an earth air pressure wherein no external pressure modifying means is utilized. Generally, unless practiced at extreme earth altitudes, “ambient pressure” is about 1 atmosphere (alternatively, about 14.7 psi or about 101 kPa).

Various numerical ranges are disclosed herein. When a range of any type is disclosed or claimed herein (e.g., “ranging from . . . ”, “in the range of from . . . ”, “in a range of from”) the intent is to disclose or claim individually each possible number that such a range could reasonably encompass, including end points of the range as well as any sub-ranges and combinations of sub-ranges encompassed therein, unless otherwise specified. For example, the present disclosure recites that the settling time is in the range of from about 10 to about 20 minutes in certain aspects. By a disclosure that the settling time can be in a range from about 10 to 20 minutes, the intent is to recite that the settling time can be any time period within the range and, for example, can be equal to about 10 minutes, about 11 minutes, about 12 minutes, about 13 minutes, about 14 minutes, about 15 minutes, about 16 minutes, about 17 minutes, about 18 minutes, about 19 minutes, or about 20 minutes. Additionally, the settling time can be within any range from about 10 minutes to 20 minutes (for example, the settling time can be in a range from about 12 minutes to about 18 minutes), and this also includes any combination of ranges between about 10 minutes to about 20 minutes. Likewise, all other ranges disclosed herein should be interpreted in a manner similar to this example.

Embodiments disclosed herein can provide the materials or components listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

Although any methods and materials similar or equivalent to those described herein can be used in the practice or testing of the subject matter described herein, the typical methods and materials are herein described.

All publications and patents mentioned herein are incorporated herein by reference for the purpose of describing and disclosing, for example, the constructs and methodologies that are described in the publications, which can be used in connection with the presently described subject matter.

### DETAILED DESCRIPTION

Illustrative aspects of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present disclosure is generally directed to one or more systems for filtering waste water (e.g., waste water formed from fish aquaculture operations), and related methods.

A. System(s) for Filtering Waste Water

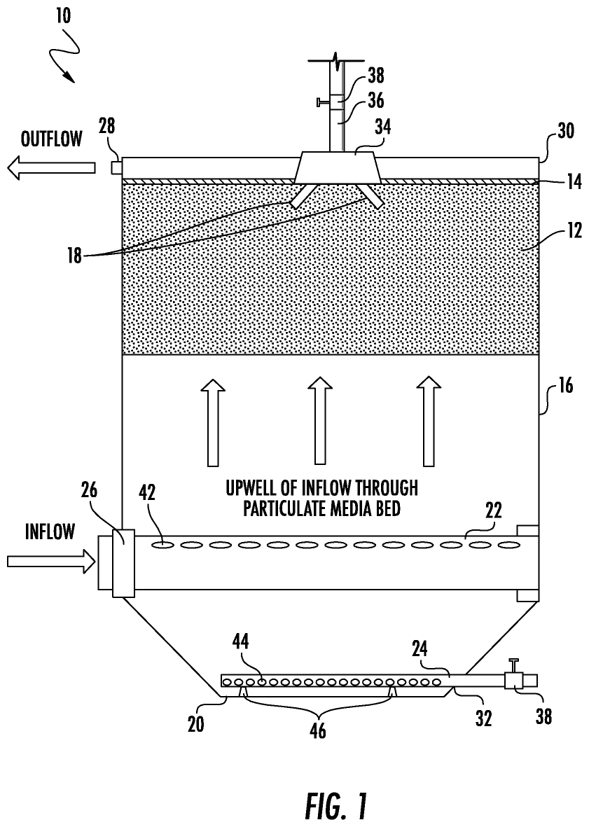

With reference to FIGS. 1-6, a system 10 for filtering waste water is provided that comprises a filter body 16 defining a bottom portion 20 and a top portion 30, at least one effluent feed line 22 extending into the filter body 16, and a particulate media bed 12 disposed and retained in the body 16. The system 10 also comprises a filter wash 34 located at or near the top portion 30 of the filter body 16. The system 10 may also comprise at least one discharge line 24 extending into the filter body 16 and configured to remove solid wastes (e.g., sludge) that may settle to the bottom of the filter body 16 during operations.

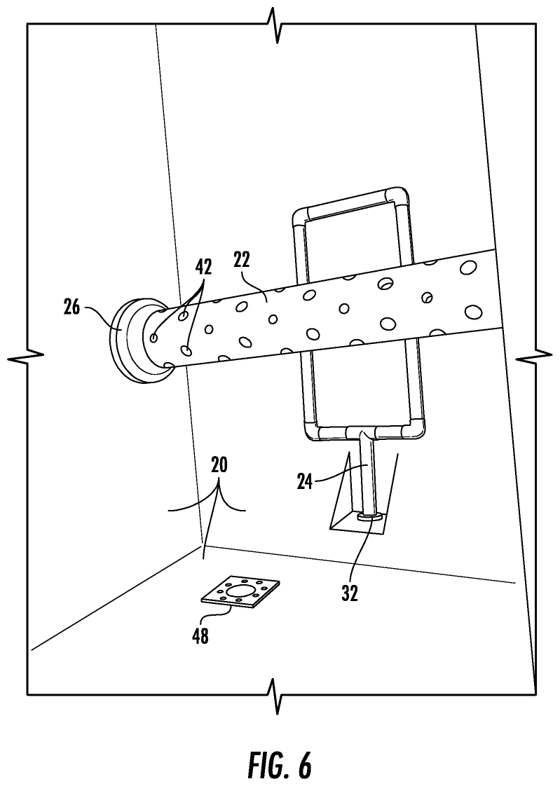

The filter body 16 may further define at least one inlet 26 disposed at or adjacent the bottom portion 20 of the filter body 16, and at least one outlet 28 disposed at or adjacent the top portion 20 of the filter body 16. The inlet 26 is configured to accept unfiltered effluent liquid via the effluent feed line 22, and the outlet 28 is configured to remove filtered effluent from the filter body 16. The filter body 16 may also define at least one discharge outlet 32 located at or near the bottom portion 30 of the filter body and configured to remove discharge (e.g., solvent, solid waste, and so forth) via the discharge line. As shown in FIG. 6, the filter body 16 may also define at least one opening or manway 48 sized and configured to permit access the bottom portion 20 of the filter body 16 for cleaning or inspection without requiring removal or disassembly of the discharge line 24. In an aspect, the filter body 16 can be a tank as shown in FIGS. 1-5. The size of the filter body 16 may be selected so as to achieve effective filtration of the effluent inflow, which can depend upon a variety of factors such as, for example, flowrate of the inflow, flow rate of the outflow, operating conditions of the system, and so forth. In an aspect, the filter body 16 has a volume in the range of from about 1 ft³ to about 1000 ft³.

The particulate media bed 12 is located between the inlet 26 and outlet 28 of the filter body 16. The particulate media bed 12 is retained in the filter body 16 by a retention means for retaining the bed at or adjacent to the top portion 30 of the filter body 16. For example, the retention means 42 may be a screen that is supported by and positioned in the filter body 16. The retention means 42 is sized so as to retain the medium of the particulate bed 12. Thus, in an aspect, the retention means 42 may define apertures that are about 2 millimeters or less than the size of the medium. For example, if the size of the medium is 7 millimeters, then the retention means 42 defines apertures that are less than about 5 millimeters. The retention means 42 may have an open area in the range of from about 40% to about 60% wherein the open area comprises the apertures. The retention means 42 may be constructed of any sufficiently durable material including without limitation stainless steel, aluminum, plastic and so forth. Examples of suitable screens include without limitation a perforated plate, a screen material, which are commercially available from McNICHOLS CO., Inc. having an address of 9401 Corporate Lake Drive, Tampa, Fla. 33634-2359, and Direct Metals Company, LLC having an address of Cobb International Blvd., Kennesaw, Ga. 30152-4390.

The particulate media bed 12 is selected so as to achieve effective filtration based upon a variety of factors including, for example, the nature of the effluent inflow introduced to the filter body 16, flow rate of the effluent inflow, and operating conditions of the system 10. In an aspect, the particulate media bed 12 has a bed depth in the range of from about 18 inches to about 20 inches. In an aspect, the medium comprising the particulate media bed 12 may have an effective size in the range of from about 4 to about 10 millimeters. The medium has a specific gravity less than about 0.98. The medium may have a specific gravity in the range of from about 0.92 to about 0.98. In an aspect, the particulate media bed 12 may be a microbe-seeded floating particulate media bed. The medium of the particulate media bed 12 may be constructed of any sufficiently durable material including without high density polyethylene (HDPE). An example of suitable medium for the particulate media bed include without limitation PE03 HDPE medium, which is commercially available from Tongxiang Small Boss Special Plastic Products Co., LTD having an address of 431 Tongsheng Road, Economic Development Zone, Tongxiang, China.

The filter wash 32 comprises one or more nozzles 18 for introducing the feed of solvent to filter body 16 so as to displace the media of media bed 12 sufficiently to dislodge at least a portion of solid waste and excess bacteria thereon and form waste wash. The filter wash 32 is positioned at or near the top portion 30 of the filter body 16 and the solvent may be fed to the filter wash 32 via a solvent feed line 36 from a solvent source. The solvent feed line 36 may also include a valve 38 for controlling flow of solvent to the filter body 16. The filter wash 32 may be supported by the filter body 16. The solvent source may be positioned so as to permit gravity flow of the solvent through the filter wash 32 and to the filter body 16. Utilizing gravity flow can provide energy savings for operating the system 10. Alternatively, a pump (not shown) may be used to feed the solvent from the solvent source to the filter body 16. The pump may be used in lieu of or in combination with the above described gravity flow configuration.

As shown in FIG. 1, during filtering operations, the one or more nozzles 18 are positioned so as to be below a plane occupied by the retention means 14. The one or more nozzles 18 are sized and configured so as to feed the solvent to the system at conditions sufficient so as to mix, fluidize and scrub the particulate media bed 12. In an aspect, the solvent may have a flow rate to the filter body in the range of from about 100 gallons/minute to about 250 gallons/minute, and may have a pressure in the range of from about 10 to about 40 psig. Examples of suitable solvent include without limitation an aqueous medium such as water.

As shown in FIGS. 1-5, the effluent feed line 22 may be supported by the filter body 16. In an aspect, the effluent feed line 22 comprises one or more perforations 42 that may be positioned along the length of a surface of the effluent feed line 22 so as to permit substantially even introduction of the effluent to the filter body 16 when effluent is supplied through the effluent feed line 22. The flow rate of the effluent inflow should be selected so as to efficiently remove solids and ammonia from the effluent inflow. A lower effluent flow rate is generally selected for removal of solids from the effluent inflow. A higher effluent flow rate is generally selected for removal of ammonia from the effluent inflow. In an aspect, the flow rate of the effluent to the filter body 16 may be in the range of from about 5 to about 20 gallons/minute per cubic foot of media. The flow rate of the effluent to the filter body 16 may be in the range of from about 8 to 10 gallons/minute per cubic foot of media. The effluent may be introduced using a pump, gravity flow configuration, or both. It should be appreciate that the effluent feed line 22 may be sized based on pipe flow hydraulics an include a safety factor. For example, the effluent feed line 22 may be oversized by about 30% to about 40% of the size necessary to accommodate a particular design flow rate.

As shown in FIGS. 1-6, the perforations 42 of the effluent feed line 22 may be directed toward the top portion 30 of the filter body 16 so as to allow the effluent to upwell through the filter body 16 and particulate media bed 12. The location and size of the one or more perforations 42 should also be selected so as to prevent or reduce high velocity areas that could cause erosion of the particulate media bed 12. In an aspect, the perforations 42 defining the effluent feed line 22 comprises greater than about 30% of the cross sectional area of the portion of the effluent feed line 22 extending into the filter body 16. Each perforation may have a diameter in the range of from about 400 to about 800 millimeters.

In an aspect, the discharge line 24 comprises one or more apertures 44. The discharge line 24 may be supported by one or more supports 46 as shown in FIGS. 1-5. The apertures 44 may be positioned along the length of a surface of the discharge line 24. The discharge line 24 may also include a valve 38 for controlling flow from the filter body 16. As shown in FIGS. 1-5, the discharge line 24 may be positioned in the filter body 16 so the apertures 44 are directed toward the bottom portion 30 of the filter body 16. The location and size of the one or more apertures 44 may be determined on a variety of factors including the characteristics of the effluent, operating conditions of the filter body, and hydraulics of the system. For example, the discharge line may have a diameter in the range of from about 2 inches to about 6 inches. Each aperture should be sized so as to be less than the diameter of the medium of the particulate bed. For example, if the medium of the particulate bed 12 has a diameter of 7 millimeters, then the apertures may have a diameter of 5 millimeters or less.

In an aspect, the system 10 may comprise two or more filter bodies 16 that are used in parallel or series. For example, the overflow from a first filter body may be fed as the effluent inflow to a second filter body. In this manner, the system can accommodate and filter large volumes of effluent.

B. Method(s) for Filtering Waste Water

A method for filtering waste water is also provided by the present disclosure. The method comprises (A) feeding effluent into a bottom portion of a tank body in which is disposed a particulate media bed, (B) retaining the particulate media bed in the filter body so that the particulate media bed is substantially static during effluent feeding and overflowing filtered output from the filter body through an outlet located at the top portion of the filter body, and (C) initiating a media wash cycle. In an aspect, the filter body 16 may be operated at ambient temperature and ambient pressure.

As shown in FIG. 1, during filtering operations using the system 10, the effluent is fed through an effluent feed line 22 into the bottom portion 20 of the filter body 16. The effluent liquid upwells through one or more perforations 42 in the effluent feed line 22 and upwardly into and through the substantially static and submerged particulate media bed 12 and out of the filter body 16 through the outlet 28, for example, as overflow through an outlet opening that is formed at the top portion 30 of the filter body 16. The retention means 14 is sized and configured to maintain the particulate media bed 12 in a substantially fixed position during effluent feeding while overflowing through the outlet 28 of the filter body 16. During filtering operations, the valve 38 of the discharge line 24 may be in a closed position so as to prevent or reduce discharge flow from the filter body 16. Similarly, during filtering operations, the valve 28 of the solvent feed line may be in a closed position so as to prevent or reduce solvent flow to the filter body 16.

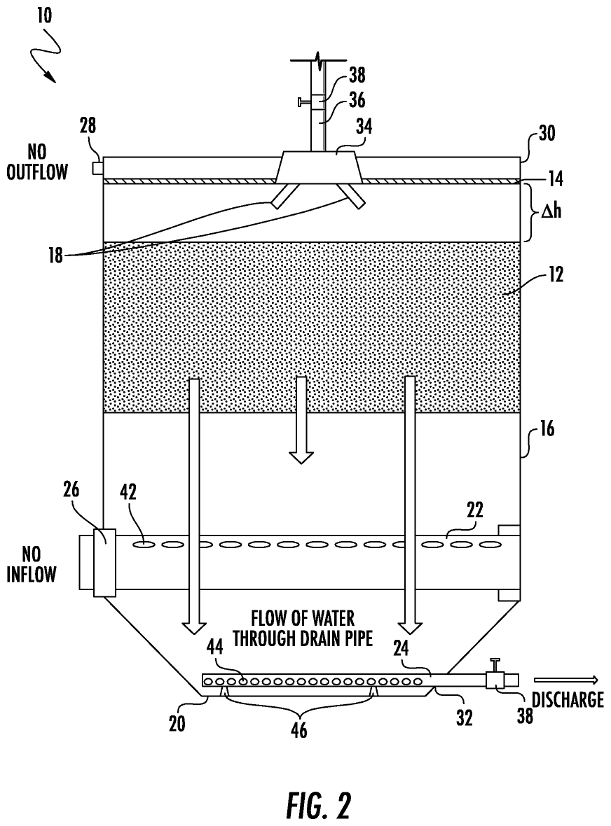

As shown in FIG. 2, the effluent inflow to the filter body 16 may be stopped, and the valve 38 of the discharge line 24 may be opened for a time sufficient so as to drain at least a portion of the contents of the filter body 16, which can permit injection of solvent through the one or more nozzles 18 of the filter wash 32. In this manner, the filter body 16 may have sufficient void space to thereby fluidize the particulate media bed 12 into a state of agitation when solvent is fed to the filter body 16 so that any solids adhered to media of the particulate media bed 12 can be dislodged therefrom. For example, the valve 38 of the discharge line 24 may be opened so as to cause the particulate media bed 12 to change or move from a first height to a second height in the filter body 16. In an aspect, the change in height Δh may be in an amount in the range of from about 12 inches to about 18 inches.

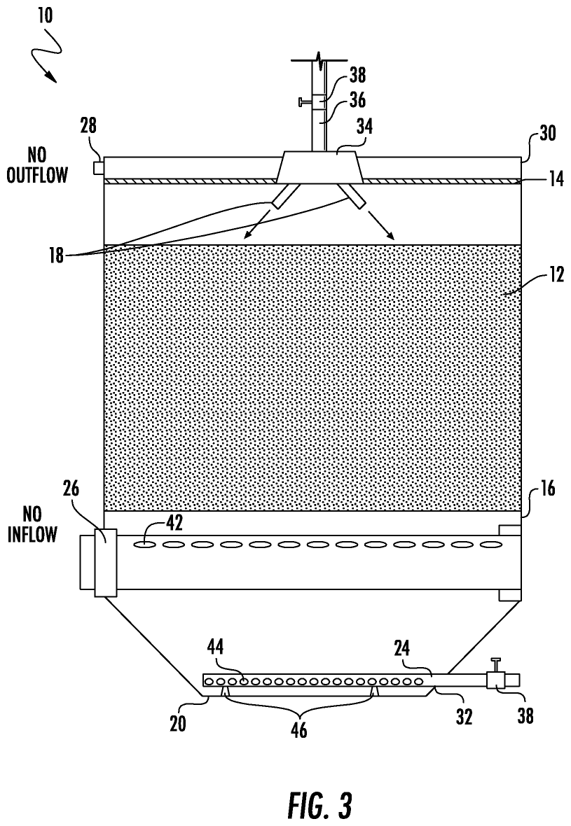

As shown in in FIG. 3, the media wash cycle is initiated. The media wash cycle comprises terminating feeding of the effluent to the filter body 16 while solvent is injected through one or more nozzles 18 of the filter wash 32 into the particulate media bed 12 to thereby fluidize the particulate media bed 12 into a state of agitation so that solids adhered to particulate media bed 12 are dislodged therefrom. To inject the solvent, the valve 38 of the solvent feed line 36 is placed into a position to allow solvent to flow through the filter wash 32. The valve 38 of the discharge line 24 may be in either the closed position or in an open position during this step.

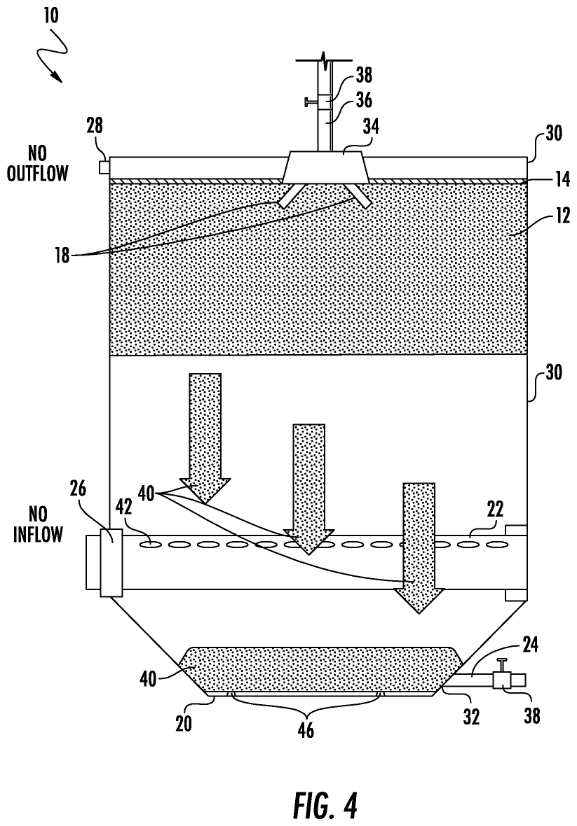

As shown in FIG. 4, the media wash cycle comprises terminating the injecting of the flow of solvent into the filter body 16, which permits dislodged waste solids 40 to settle out of the particulate media bed 12 and to the bottom portion 20 of the filter body 16. The valve 38 of the discharge line 24 may be in either the closed position or in an open position during this step.

After a sufficient amount of settling time is provided to permit waste solids 40 to settle to the bottom portion 20 of the filter body 16, the valve 38 of the discharge line 24 is opened to drain the bottom portion 20 of the filter body 16 to remove waste solids 40 from the filter body 16. Alternatively or in addition, if the filter body also includes an opening or manway 48, then solid wastes 42 may be removed from the filter body 16 through the opening or manway 48. In an aspect, the settling time may be in the range of from about 10 to about 20 minutes.

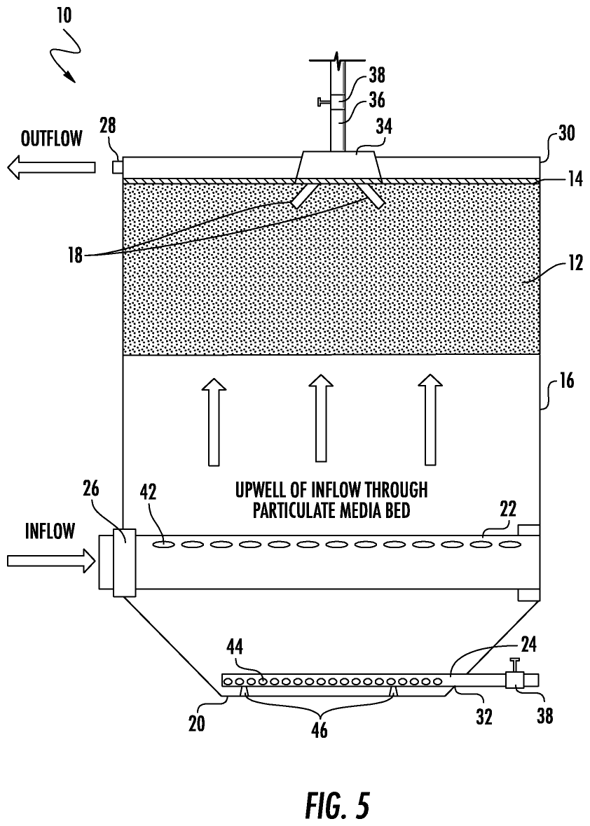

As shown in FIG. 5, once a desired amount of solid wastes 40 are removed from the filter body 16, draining of the bottom portion of the filter body 16 is terminated and the method may be repeated as desired or needed.

The subject matter is described above with reference to numerous aspects and specific examples. Many variations will suggest themselves to those skilled in the art in light of the above detailed description. All such obvious variations are within the full intended scope of the appended claims. Other aspects of the subject matter disclosed herein can include, but are not limited to, the following (aspects are described as “comprising” but, alternatively, can “consist essentially of”, or “consist of”):

Aspect 1. A system for filtering waste water, the system comprising:

(A) at least one effluent feed line configured to receive an effluent liquid to be filtered and extending into a respective filter body, the filter body defining a bottom portion and a top portion; and

(B) a microbe-seeded, floating particulate media bed disposed and retained in the filter body by retention means for retaining the particulate media bed at or adjacent to the top portion of the filter body;

wherein, during filter operation, the effluent liquid upwells through one or more perforations in the effluent feed line and upwardly into and through the particulate media bed and out of the filter body through an opening formed at the top portion of the filter body, the particulate media bed remaining substantially static; and

wherein during media washing operation the particulate media bed becomes fluidized as the result of a feed of a solvent through one or more nozzles introducing the feed of solvent to filter body below a plane occupied by the retention means, so as to displace the medium of the particulate media bed sufficiently to dislodge at least a portion of solid waste and excess bacteria thereon and form waste wash, the waste wash thereafter settling to the bottom portion of the filter body following termination of the feed of the solvent through the one or more nozzles, the filter body further comprising one or more discharge outlets for draining the filter body and media bed of the settled waste wash following termination of the feed of solvent through the one or more nozzles and preparatory to the particulate media bed being placed back into service for repeated filtering operation upon the resumption of effluent feeding into the effluent feed line.

Aspect 2. A system as defined by Aspect 1, wherein the waste water comprises waste water formed from fish aquaculture operations.

Aspect 3. A system as defined by any of Aspects 1-2, wherein the retention means comprises a screen.

Aspect 4. A system as defined by any of Aspects 1-3, wherein the particulate media bed comprises one or more floating filter beds.

Aspect 5. A method for filtering waste water, comprising:

feeding effluent through an effluent feed line into a bottom portion of a filter body in which is disposed a floating, microbe-seeded, particulate media,

retaining the particulate media in the filter body so that the particulate media is substantially static during effluent feeding while overflowing a filtered output from the filter body through a top portion of the filter body,

initiating a media wash cycle, the wash cycle comprising:
terminating the feeding of effluent while injecting a flow of solvent through one or more solvent feed lines into the particulate media, to thereby fluidize the particulate media into a state of agitation so that solids adhered to the medium are dislodged therefrom,
terminating the injecting of the flow of solvent to permit dislodged waste solids to settle out of the particulate medium and settle in the bottom portion of the filter body, and
draining the bottom portion of the filter body to remove waste solids settled in the bottom portion of the filter body, and
terminating the draining of the bottom portion of the filter body, and repeating the method.

Aspect 6. A method as defined by Aspect 5, wherein the solvent is water or an aqueous medium.

Aspect 7. A method as defined by any of Aspects 5-6, wherein the waste water comprises waste water formed from fish aquaculture operations.

Aspect 8. A method for filtering waste water formed from fish aquaculture operations, the method comprising:

(A) feeding effluent through an effluent feed line into a bottom portion of a filter body in which is disposed a particulate media bed,

(B) retaining the particulate media bed in the filter body so that the particulate media bed is substantially static during effluent feeding;

(C) overflowing a filtered output exiting the particulate media bed through a top portion of the filter body;

(D) terminating the feeding of effluent to the filter body;

(E) injecting a flow of solvent through a filter wash into the particulate media bed thereby fluidizing the particulate media bed into a state of agitation so that solids adhered to the particulate media bed are dislodged therefrom;

(F) terminating the injecting of the flow of solvent to permit dislodged waste solids to settle in the bottom portion of the filter body; and

(G) draining the bottom portion of the filter body to remove waste solids settled in the bottom portion of the filter body.

1. A system for filtering waste water, the system comprising:
(A) at least one effluent feed line configured to receive an effluent liquid to be filtered and extending into a respective filter body, the filter body defining a bottom portion and a top portion;
(B) a microbe-seeded, floating particulate media bed disposed and retained in the filter body by retention means for retaining the particulate media bed at or adjacent to the top portion of the filter body; and
(C) a filter wash comprising one or more nozzles, wherein the filter wash is positioned at the top portion of the filter body;
wherein, during filter operation, the effluent liquid upwells through one or more perforations in the effluent feed line and upwardly into and through the particulate media bed and out of the filter body through an opening formed at the top portion of the filter body, the particulate media bed remaining substantially static; and
wherein during media washing operation the particulate media bed becomes fluidized as the result of a feed of a solvent through the one or more nozzles introducing the feed of solvent to the filter body below a plane occupied by the retention means, so as to displace the medium of the particulate media bed sufficiently to dislodge at least a portion of solid waste and excess bacteria thereon and form waste wash, the waste wash thereafter settling to the bottom portion of the filter body following termination of the feed of the solvent through the one or more nozzles, the filter body further comprising one or more discharge outlets for draining the filter body and media bed of the settled waste wash following termination of the feed of solvent through the one or more nozzles and preparatory to the particulate media bed being placed back into service for repeated filtering operation upon the resumption of effluent feeding into the effluent feed line.

2. The system according to claim 1, wherein the waste water comprises waste water formed from fish aquaculture operations.

3. The system according to claim 2, wherein the retention means comprises a screen.

4. The system according to claim 1, wherein the particulate media bed comprises one or more floating filter beds.

5. A method for filtering waste water, comprising:
feeding effluent through an effluent feed line into a bottom portion of a filter body in which is disposed a floating, microbe-seeded, particulate media,
retaining the particulate media in the filter body so that the particulate media is substantially static during effluent feeding while overflowing a filtered output from the filter body through a top portion of the filter body,
initiating a media wash cycle, the wash cycle comprising:
terminating the feeding of effluent while injecting a flow of solvent through one or more solvent feed lines and a filter wash into the particulate media, to thereby fluidize the particulate media into a state of agitation so that solids adhered to the medium are dislodged therefrom, wherein the filter wash comprises one or more nozzles positioned at the top portion of the filter body and in fluid communication with the one or more solvent feeds lines,
terminating the injecting of the flow of solvent to permit the dislodged waste solids to settle out of the particulate media and settle in the bottom portion of the filter body, and
draining the bottom portion of the filter body to remove the waste solids settled in the bottom portion of the filter body, and
terminating the draining of the bottom portion of the filter body.

6. The method of claim 5, wherein the solvent is water or an aqueous medium.

7. The method of claim 6, wherein the waste water comprises waste water formed from fish aquaculture operations.

8. A method for filtering waste water formed from fish aquaculture operations, the method comprising:
(A) feeding effluent through an effluent feed line into a bottom portion of a filter body in which is disposed a particulate media bed,
(B) retaining the particulate media bed in the filter body so that the particulate media bed is substantially static during effluent feeding;
(C) overflowing a filtered output exiting the particulate media bed through a top portion of the filter body;
(D) terminating the feeding of effluent to the filter body;
(E) injecting a flow of solvent through a filter wash into the particulate media bed thereby fluidizing the particulate media bed into a state of agitation so that solids adhered to the particulate media bed are dislodged therefrom, wherein the filter wash comprises one or more nozzles positioned at the top portion of the filter body;
(F) terminating the injecting of the flow of solvent to permit the dislodged waste solids to settle in the bottom portion of the filter body; and
(G) draining the bottom portion of the filter body to remove the waste solids settled in the bottom portion of the filter body.

9. The method of claim 5, wherein the solvent is gravity fed through one or more solvent feed lines and a filter wash into the particulate media.

10. The method of claim 9, wherein the filter body is operated at ambient temperature and ambient pressure.

11. The method of claim 8, wherein in step (E) the injecting of the flow of solvent occurs by gravity feeding the solvent through a filter wash into the particulate media.

12. The method of claim 11, wherein the filter body is operated at ambient temperature and ambient pressure.
